(19) United States
(12) Patent Application Publication
(10) Pub. No.: US 2010/0066171 A1
(43) Pub. Date: Mar. 18, 2010

(54) MULTIPLE POWER SOURCE POWER SUPPLY

(75) Inventors: Roshan Thakur, Sunnyvale, CA (US); Zoltan Zansky, Sunnyvale, CA (US)

Correspondence Address: NETAPP (c/o SUITER SWANTZ PC LLO), 14301 FNB PARKWAY, SUITE 220, OMAHA, NE, 68154-5299, US

(73) Assignee: NETAPP, INC., Sunnyvale, CA (US)

(21) Appl. No.: 12/211,511

(22) Filed: Sep. 16, 2008

(51) Int. Cl. H02J 1/10

(52) U.S. Cl. 307/43

(57) ABSTRACT

A multiple power source power supply may include multiple power sources fed by separate power sources. A multiple power source power supply may also include a first power factor correction circuitry and a second power factor correction circuitry. A multiple power source power supply may also include a single converter. A plurality of multiple power source power supplies may be combined to provide a cost and energy efficient power supply system.

### TECHNICAL FIELD

The present disclosure generally relates to the field of power supply systems, and more particularly to a multiple power source power supply.

### BACKGROUND

Electrical energy in the form of Alternating Current (AC) is a commonly available power source found in buildings, including homes. AC power is typically supplied by a central utility via power lines or from a physical plant that is part of a facility. However, many common devices, including electronic circuits and DC motors, utilize electrical energy in the form of Direct Current (DC), which is electrical current that flows in only one direction. Thus, it is often desirable to convert AC power to DC power.

Power supply systems convert AC power to DC power suitable for powering electrical components, also known as a load. It is often desirable to combine multiple redundant power supplies in parallel to supply a given load requirement. When power supplies are combined in parallel, the output of each power supply may be combined to produce a shared output, or common output load. When multiple power supplies are combined in parallel, reliability and efficiency for the power supply system may be improved. Redundant parallel-connected power supplies may increase reliability for the overall power supply system whereby a failure of a power supply will cause other power supplies to supply enough current for support of a maximum load.

Multiple power supplies combined in parallel typically operate at a light load during their normal operation and thus may operate at poor efficiency. Additionally, each power supply of a redundant pair of power supplies are typically a full capacity power supply operable to handle a total load, which causes a power requirement overcapacity and increases a total cost of the power supply system.

### SUMMARY

Accordingly, the present disclosure is directed to a multiple power source power supply. In one embodiment, a multiple power source power supply may include multiple power inputs fed by separate power sources. A multiple power source power supply may also include multiple electromagnetic interference (EMI) filters, multiple rectifier bridges and multiple power factor correction controllers. A multiple power source power supply may include a single converter that may supply a stable voltage to a load. In an embodiment, a plurality of multiple power source power supplies may be combined to operate in parallel and provide a cost and energy efficient power supply system.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a diagram illustrating a single power source power supply;

FIG. 2 is a diagram illustrating a multiple power source power supply;

FIG. 3 is a block diagram of a power supply system including a plurality of multiple power source power supplies;

FIG. 4 is an exemplary efficiency graph of an efficiency of a power supply across a load percentage;

FIG. 5 is a flow diagram representing a method for supplying power for a data storage system.

### DETAILED DESCRIPTION

Reference will now be made in detail to the subject matter disclosed, which is illustrated in the accompanying drawings.

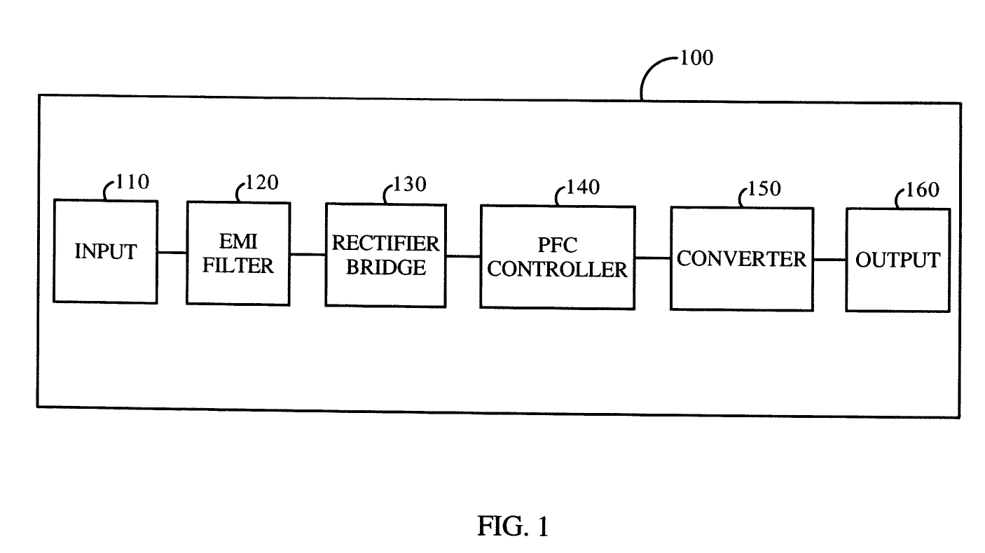

Referring to FIG. 1, an embodiment of a block diagram of a single power source power supply 100 is shown. A single power source power supply 100 may include an input 110. Input 110 may be a power source. Input 110 may receive an alternating current (AC) feed supply. An electromagnetic interference (EMI) filter 120 may be coupled to input 110. An EMI filter may prevent interference on an AC mains supply. Bridge rectifier 130 may receive an output of the EMI filter 120 and may convert an AC voltage to a unipolar pulsating voltage. Bridge rectifier 130 may include four diodes in a bridge arrangement to provide the same polarity of output voltage for both polarities of input voltage. A power factor correction (PFC) controller 140 may receive a rectified input voltage from bridge rectifier 130. PFC 140 may reduce reactive power within the power supply 100. A converter 150 may receive the output of PFC 140 and may provide at least one stable DC voltage. Converter 150 may provide input-to-output transformer isolation. Converter 150 may be any type of topology, including full bridge, half-bridge, forward and flyback. Output 160 may be coupled to converter 150 and may supply a voltage to a load.

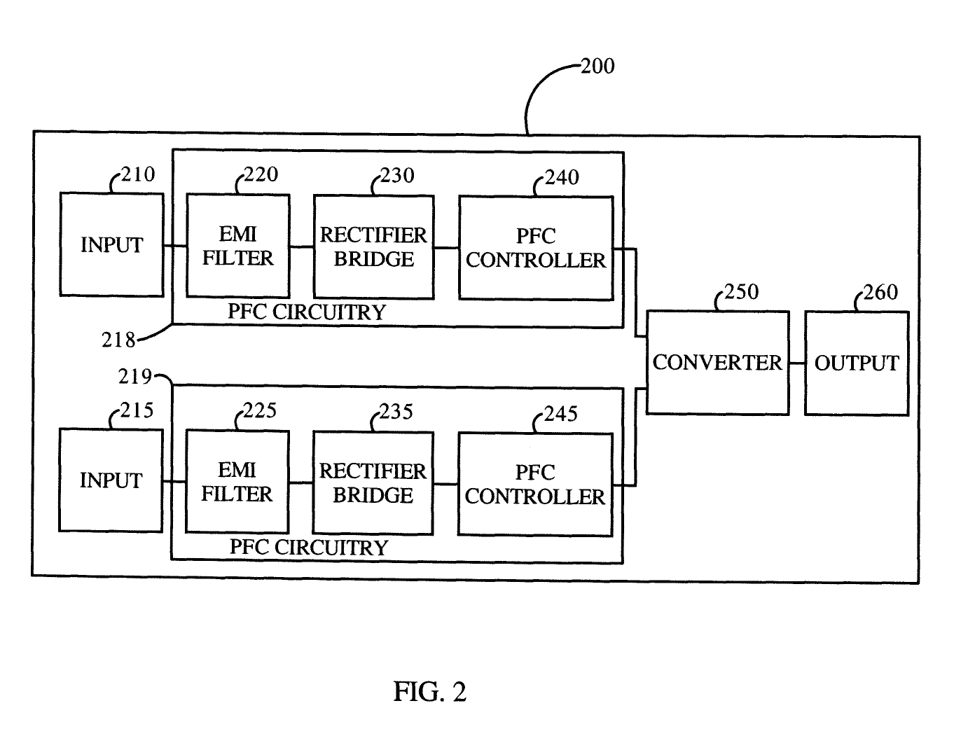

Referring to FIG. 2, an embodiment of a block diagram of a multiple power source power supply 200 is shown. Multiple power source power supply 200 may include a housing. Within the housing, multiple power source power supply may include two inputs 210, 215 fed by separate power sources. Inputs 210, 215 may receive alternating current (AC) power. Power sources may be separate AC supply branches. For example, a first power source may be an AC mains supply where a second power source may be supplied through a diesel generator, and the like. Multiple power source power supply 200 may further include a first power factor correction (PFC) circuitry, a second PFC circuitry, a converter and output. First PFC circuitry 218 may convert an AC power source from input 210 to a DC power output supplied to converter 250. Second PFC circuitry 219 may convert an AC power source from input 215 to a DC power output supplied to transformer-isolated converter 250. Converter 250 may produce a stable output DC voltage to for a load supplied to the load via output 260. Converter 250 may produce a reduced DC voltage than the DC power output supplied to the converter 250 by one of the first PFC circuitry 218 and second PFC circuitry 219.

First PFC circuitry 218 may include an electromagnetic filter 220, a rectifier bridge 230 and a power factor correction controller 240. Second PFC circuitry 219 may include electromagnetic filter 225, a rectifier bridge 235 and a power factor correction (PFC) controller 245. Electromagnetic interference (EMI) filter 220 may be coupled to input 210 and electromagnetic interference filter 225 may be coupled to input 215. Bridge rectifier 230 may receive an output of the EMI filter 220. Bridge rectifier 235 may receive an output of EMI filter 225. Power factor correction controller 240 may be coupled to bridge rectifier 230 while power factor controller 235 may be coupled to bridge rectifier 235. The output of PFC controllers 240, 245 may be combined and supplied to a single converter 250.

The output of PFC controllers 240, 245 may be coupled to an OR diode circuit or similar device for combining redundant power providers, the output of the OR diode circuit being coupled with converter 240. OR diode circuit may provide isolation for power supply 200 and may prevent reverse current flow within power supply 200. OR diodes may be a conventional diode and may be a Schottky diode. In another embodiment, OR diodes may be implemented with a field effect transistor and a driver. For example, OR diodes may be implemented as a body diode of a transistor, such as a MOSFET, whereby the transistor is turned on, shunting the body diode with a very low voltage drop when the current is moving through the body diode. Output 260 may be coupled to converter 250 and may supply a voltage to a load.

Power supply 200 may operate to provide reliable power through operation of a backup power source, such as a second AC power source. For example, first PFC circuitry 218 may provide the DC output to converter 250 when the first AC power source is operable. However, second PFC circuitry 219 may provide the DC output to converter 250 when said first AC power source is un-operable. In this instance, second AC power source may supply power to second input which is received by second PFC circuitry 219.

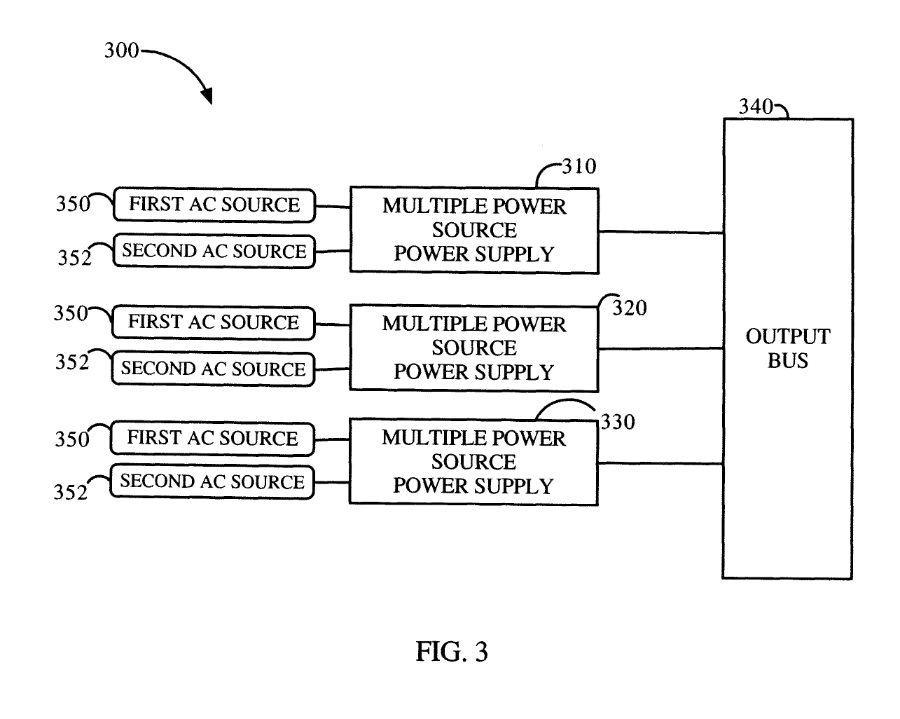

Referring to FIG. 3, a block diagram of a power supply system 300 including a plurality of multiple power source power supplies is shown. Power supply system 300 may be a redundant power supply system and may operate more efficiently than conventional redundant power supply systems with reduced hardware costs. For example, a conventional power supply system may include two power supplies, each power supply with a power rating equivalent to a full system load requirement. As a result, if one power supply should fail, the other power supply may provide full power to support the load requirement. Typical operation of a conventional power supply system, a system load is around 40% of the full system load requirement. After employing current sharing amongst each power supply, each power supply may operate at about twenty percent (20%) of their rated load, which is a low percentage and consequently each power supply operates at low efficiency.

Additionally, power supply systems, including power supply system 300, may include current sharing circuitry. Current sharing circuitry may ensure that each power supply of a multiple power supply system may equally, or approximately equally, supply current to the load. For example, two power supplies may share the current within 10% of its full load current. If the maximum rated output current of an output is 50 amperes (A), then the difference between two or more supplies may be within 5 A.

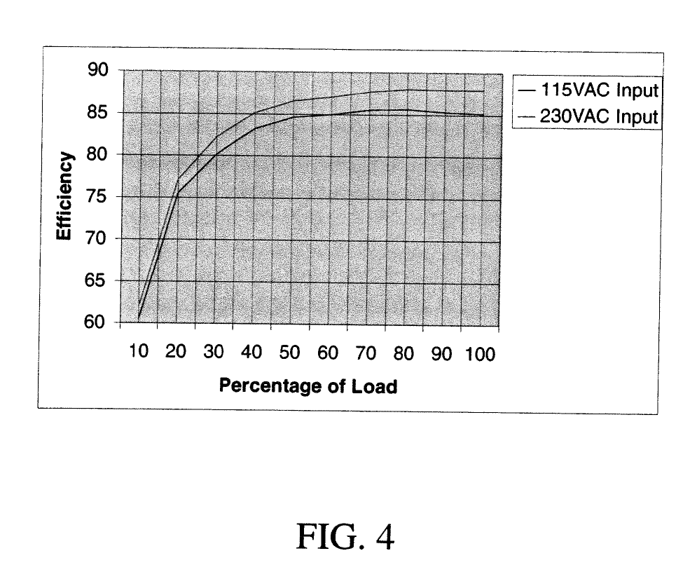

When power supplies operate at light loads (for example, 20% of full load) current sharing accuracy decreases. Through employing current sharing, a first power supply may operate 17.5% of its rated power while a second power supply may operate at 22.5% of its rated power. Referring to FIG. 4, an exemplary efficiency graph of an efficiency of a power supply across a load percentage is shown. At 17.5% of its rated power, a first power supply may operate at approximately 75% efficiency. At 22.5% of its rated power, the second power supply may operate at approximately 78%. With a 400 W load, this reduced efficiency may result in a power loss of a first power supply of 58 watts (W) while the power loss of the second power supply may be 63 W, for a total of 121 W. Additionally, the hardware cost of a single input, 1000 watt power supply may be $100.00 each, for a total cost of $200.00 for two power supplies.

Referring again to FIG. 3, power supply system 300 may include a plurality of multiple power source power supplies 310-330 with a reduced power rating which may produce a more efficient power supply system 300. It is contemplated that power supplies 310-330 may be implemented as power supply 200 of FIG. 2. In one embodiment, three multiple power source power supplies may be combined to supply an output bus 340. The combination of multiple power source supplies may include an OR diode circuit between the output of the multiple power source power supplies and the output bus 340.

OR diode circuit may provide isolation for power supplies 310-330 and may prevent reverse current flow within power supplies 310-330. OR diodes may be a conventional diode and may be a Schottky diode. In another embodiment, OR diodes may be implemented with a field effect transistor and a driver. For example, OR diodes may be implemented as a body diode of a transistor, such as a MOSFET, whereby the transistor is turned on, shunting the body diode with a very low voltage drop when the current is moving through the body diode.

Multiple power source power supplies 310-330 may be in communication with each other such that, if one power supply should fail, the other power supplies may supply the full load. It is contemplated that power supplies 310 may employ current sharing circuits. If one power supply fails, the other power supplies may automatically adjust their output current for the same total output current to the common load. Additionally, each power supply 310-330 may be supplied by multiple AC power sources 350, 352. If a first AC power source 350 should fail, a second AC power source 352 may supply power to the power supplies 310-330 which may supply a desired output voltage and power to output bus 340.

Operation of power supply system 300 may result in additional cost savings. In the example of a 1000 Watt power supply system, three multiple power source, 500 W, power supplies may supply power at 11 cents/watt, or $55.00 each for a total of hardware costs of $165.00, less than the $200.00 cost of two 1000 watt, single input power supplies. Additionally, the operating cost may be reduced through greater operating efficiency of each power supply. In the example of a system load of 400 W, an ideal current sharing by each power supply 310-330 may operate at 133 W which is 27% of a maximum load of 500 W. When each power supply is operating at 27% of the maximum load of 500 W, each power supply may operate at 82% efficiency as shown in FIG. 4. Thus the power loss of each power supply is 29 W, for a total loss of 87 W. The power loss of 87 W is less than the typical loss of 121 W of two single input power supplies as described above.

It is contemplated that power supply system 300 may be employed with information handling systems, such as computing systems of a data storage system and/or storage rack, shelf and the like. Data storage systems require reliable power to ensure valid read and write access to data on a continuous basis. Power supply system 300 may ensure a reliable power delivery to the data storage system.

Additionally, computing systems and data storage systems that comprise a data center consume a significant amount of power. Since there is a demand for constant access to data, there is an inability to reduce power through reduced consumption. Consequently, power efficiency is desirable. Power supply system 300 may provide reduced power loss through higher operating efficiency while providing a reliable power supply system. A data storage system employing a power supply system 300 of the present invention may increase reliability of the data storage system while reducing power consumption and cost. Power supply system 300 may be modified to employ a number of multiple power source power supplies greater than three for additional flexibility.

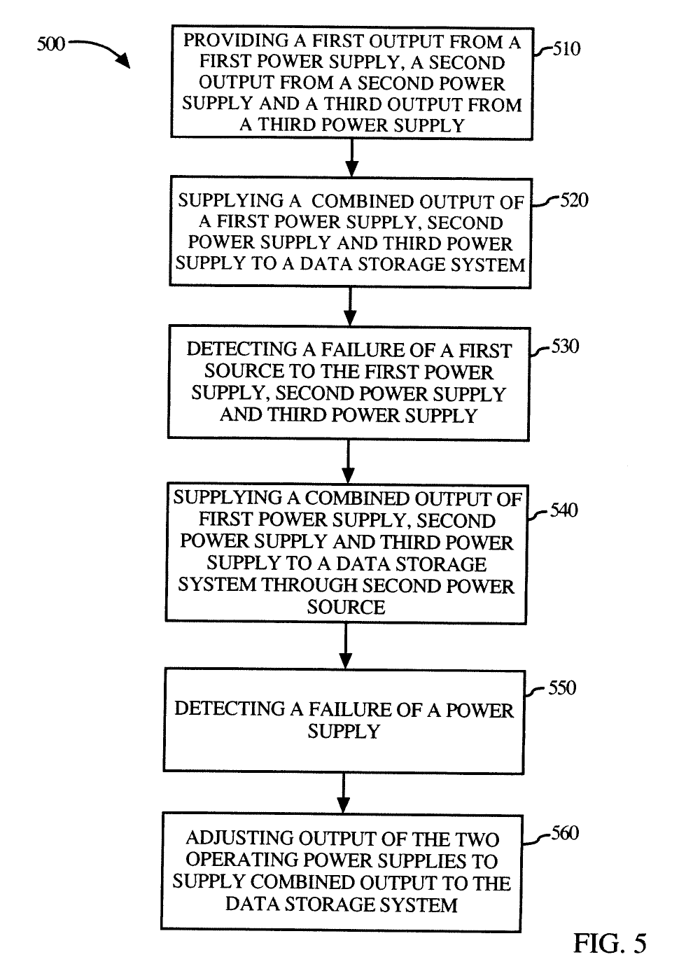

Referring to FIG. 5, a flow diagram representing a method 500 for supplying power for a data storage system. It is contemplated that power supply system 300 may execute method 500 for supplying power for a data storage system. Method 500 may begin by providing a first output from a first multiple power source power supply, a second output from a second multiple power source power supply and a third output from a third multiple power source power supply 510. Next, method 500 may include supplying a combined output of the first multiple power source power supply, second multiple power source power supply and third multiple power source power supply to a data storage system 520.

Method 500 may further include detecting a failure of a first power source of multiple power sources to the first multiple power source power supply, second multiple power source power supply and third multiple power source power supply 530. Method 500 may include supplying a combined output of the first multiple power source power supply, second multiple power source power supply and third multiple power source power supply to a data storage system by utilizing a second power source of multiple power sources 540.

Method 500 may further include detecting a failure of a multiple power source power supply 550. In response, method 500 may include adjusting output of two operating multiple power source power supplies to supply the common output to the data storage system and maintain operation of the data storage system despite the failure of a power supply. It is contemplated that method 500 may allow data storage system to remain reliably operable even in the case of a power source failure or a power supply failure. Additionally, method 500 may be executed in a power efficient manner with the use of multiple power source power supplies 200 as shown in FIG. 2.

It is believed that the system of the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A power supply, comprising:
a first input, said first input for receiving alternating current (AC) power;
a second input, said second input for receiving AC power;
a first power factor correction (PFC) circuitry, said first PFC circuitry coupled to said first input, said first PFC circuitry configured for converting AC power received from said first input into a direct current (DC) output;
a second PFC circuitry, said second PFC circuitry coupled to said second input, said second PFC circuitry configured for converting AC power from said second input into a DC output;
a single converter, said single converter coupled to an output of said first PFC circuitry and said second PFC circuitry, said single converter producing a DC voltage of a different voltage than said DC output from at least one of said first PFC circuitry or said second PFC circuitry.

2. The power supply as claimed in claim 1, wherein said first PFC circuitry includes:
an electromagnetic interference filter;
a rectifier bridge coupled to said electromagnetic interference filter; and
a power factor correction controller coupled to said rectifier bridge.

3. The power supply as claimed in claim 2, wherein said second PFC circuitry includes:
an electromagnetic interference filter;
a rectifier bridge coupled to said electromagnetic interference filter; and
a power factor correction controller coupled to said rectifier bridge.

4. The power supply as claimed in claim 3, further including an OR diode circuit coupled to an output of said power factor correction controller of said first PFC circuitry, an output of said power factor correction controller of said second PFC circuitry and said single converter.

5. The power supply as claimed in claim 1, wherein said first input is coupled to a first AC power source and said second input is coupled to a second AC power source.

6. The power supply as claimed in claim 5, wherein said first PFC circuitry provides said DC output to said single converter when said first AC power source is operable.

7. The power supply as claimed in claim 5, wherein said second PFC circuitry provides said DC output to said single converter when said first AC power source is un-operable.

8. A power supply system, comprising:
a first multiple power source power supply, said first multiple power source power supply including:
a first input, said first input for receiving alternating current (AC) power;
a second input, said second input for receiving AC power; and
an output, said first multiple power source power supply providing DC power at said output;
a second multiple power source power supply, said second multiple power source power supply including:
a first input, said first input for receiving AC power;
a second input, said second input for receiving AC power; and
an output, said second multiple power source power supply providing DC power at said output;
a third multiple power source power supply, said third multiple power source power supply including:
a first input, said first input for receiving AC power;
a second input, said second input for receiving AC power; and
an output, said third multiple power source power supply providing DC power at said output; and
an output voltage bus, said output voltage bus coupled to said output of said first multiple power source power supply, said output of said second multiple power source power supply and said output of said third multiple power source power supply, wherein a desired voltage is provided by the output voltage bus, said desired voltage being provided upon a failure of one of said first multiple power source power supply, said second multiple power source power supply or said third multiple power source power supply.

9. The power supply system as claimed in claim 8, wherein said first multiple power source power supply, said second multiple power source power supply and said third multiple power source power supply each include:
a first power factor correction (PFC) circuitry, said first PFC circuitry coupled to said first input, said first PFC circuitry configured for converting AC power received from said first input into a direct current (DC) output; and
a second PFC circuitry, said second PFC circuitry coupled to said second input, said second PFC circuitry configured for converting AC power from said second input into a DC output.

10. The power supply system as claimed in claim 9, wherein said first PFC circuitry includes:
an electromagnetic interference filter;
a rectifier bridge coupled to said electromagnetic interference filter; and
a power factor correction controller coupled to said rectifier bridge.

11. The power supply system as claimed in claim 10, wherein said second PFC circuitry includes:
an electromagnetic interference filter;
a rectifier bridge coupled to said electromagnetic interference filter; and
a power factor correction controller coupled to said rectifier bridge.

12. The power supply system as claimed in claim 11, wherein said first multiple power source power supply, said second multiple power source power supply and said third multiple power source power supply each include a single converter coupled to an output of said first PFC circuitry and said second PFC circuitry, said single converter producing a DC voltage of a different voltage than said DC output from at least one of said first PFC circuitry or said second PFC circuitry.

13. The power supply system as claimed in claim 12, wherein said first multiple power source power supply, said second multiple power source power supply and said third multiple power source power supply each include an OR diode circuit coupled to an output of said power factor correction controller of said first PFC circuitry, an output of said power factor correction controller of said second PFC circuitry and said single converter.

14. The power supply system as claimed in claim 13, wherein said first input of said first multiple power source power supply, said second multiple power source power supply and said third multiple power source power supply is coupled to a first AC power source and said second input is coupled to a second AC power source.

15. The power supply system as claimed in claim 14, wherein said first PFC circuitry of said first multiple power source power supply, said second multiple power source power supply and said third multiple power source power supply provides said DC output to said single converter when said first AC power source is operable.

16. The power supply system as claimed in claim 15, wherein said second PFC circuitry of said first multiple power source power supply, said second multiple power source power supply and said third multiple power source power supply provides said DC output to said single converter when said first AC power source is un-operable.

17. A method for providing power, comprising:
providing a first output from a first multiple power source power supply, a second output from a second multiple power source power supply and a third output from a third multiple power source power supply;
supplying a combined output of said first multiple power source power supply, said second output from said second multiple power source power supply and said third output from said third multiple power source power supply to a data storage system;
detecting a failure of a first power source;
supplying said combined output of said first multiple power source power supply, said second output from said second multiple power source power supply and said third output from said third multiple power source power supply to a data storage system through a second power source;
detecting a failure of a multiple power source power supply from said first multiple power source power supply, said second multiple power source power supply and said third multiple power source power supply;
adjusting output of two operating multiple power source power supplies to supply said combined output to the data storage system.

18. The method as claimed in claim 17, wherein said detecting a failure of a first power source includes detecting a failure of an alternating current (AC) mains supply.

19. The method as claimed in claim 18, wherein said data storage system is operable upon said failure of said AC mains supply.

20. The method as claimed in claim 17, wherein said data storage system is operable upon said failure of a multiple power source power supply.
